(19) United States
(12) Patent Application Publication
(10) Pub. No.: US 2021/0407036 A1
(43) Pub. Date: Dec. 30, 2021

(54) METHOD AND ARRANGEMENT FOR IDENTIFYING OBJECT

(71) Applicant: TRACY OF SWEDEN AB, Virserum (SE)

(72) Inventors: Ulf ERLANDSSON, Onsala (SE); Jan-Erik RENDAHL, Stockholm (SE); Jonny EDVARDSSON, Virserum (SE)

(21) Appl. No.: 17/290,433

(22) PCT Filed: Nov. 1, 2019
(86) PCT No.: PCT/IB2019/059393

§ 371 Date: Apr. 30, 2021

(30) Foreign Application Priority Data
Nov. 3, 2018 (SE) 1830320-6

(51) Int. Cl. G06T 3/00; G06T 7/80; H04N 17/00; G06K 9/78; H04N 5/232; G06T 5/00

(52) U.S. Cl. CPC G06T 3/0012; G06T 7/80; H04N 17/002; G06K 9/78; H04N 5/23299; A01G 23/099; H04N 5/23229; G06T 3/0093; G06T 5/006; G06T 2207/30244; G06T 2207/30161; H04N 5/23248

(57) ABSTRACT

Disclosed is a method of identifying an object using at least one imaging. The method comprises acquiring calibration information for each of the imaging device arranged substantially perpendicular to a planar surface of the object, capturing an image of the planar surface using each of the imaging device, generating a transformed image corresponding to each image of the planar surface, using the calibration information of the imaging device used for capturing each image, generating a security map for each transformed image, wherein the security map comprises a weightage factor for each pixel of the transformed image, and wherein the weightage factor is based on image resolution of the transformed image, and constructing a resultant image of the planar surface using each transformed image and the security map for the transformed image, to identify the object.

### TECHNICAL FIELD

The present disclosure relates to arrangements for use in timber industries. Furthermore, the present disclosure also relates to methods of implementing aforementioned arrangement. Moreover, the present disclosure also relates to systems for using aforementioned arrangement in timber industries.

### BACKGROUND

In timber industries, identification of a given log (lumber) is critical for the supply chain of timber products. The identification of the given log allows for categorization, classification and identification of the log. Currently, with the development of information technology, the camera arrangements have been used for categorization, classification and identification of logs. Furthermore, in such conventional camera arrangements one or more imagery devices (such as cameras) are mounted on the harvesters to acquire one or more images of objects such as logs.

However, such conventional camera arrangement used for categorization, classification and identification of logs include a number of problems. One of such problems associated with the conventional camera arrangements relates to the unclear images used for the identification of logs. Furthermore, owing to hardware constraints the cameras of the conventional camera arrangements may be mounted differently in different harvesters. Additionally, the one or more image generated by differently positioned cameras can be significantly different for a given log. Thus, the results generated by the conventional camera arrangements may be unreliable. Moreover, the perspective camera projection of the cameras of the conventional camera arrangements may distort the images. Such distortion in images makes it harder to compare two images taken for a given log from different angles. Therefore, conventional camera arrangements may not be efficient for identification of logs. Also, harvesting is a turbulent process which makes the process of acquiring suitable images difficult. Consequently, identification of logs using the conventional camera arrangements may be inherently defective.

Therefore, in light of the foregoing discussion, there exists a need to overcome the aforementioned drawbacks associated with the conventional methods and arrangement for identifying an object such as a log.

### SUMMARY

The present disclosure seeks to provide a method of identifying an object using at least one imaging device.

The present disclosure also seeks to provide an arrangement for identifying an object.

The present disclosure also seeks to provide a system for identifying a log.

In a first aspect, an embodiment of the present disclosure provides a method of identifying an object using at least one imaging device, wherein the method comprises:
acquiring calibration information for each of the at least one imaging device arranged substantially perpendicular to a planar surface of the object;
capturing an image of the planar surface of the object using each of the at least one imaging device;
generating a transformed image corresponding to each image of the planar surface of the object, using the calibration information of the at least one imaging device used for capturing each image;
generating a security map for each transformed image, wherein the security map comprises a weightage factor for each pixel of the transformed image, and wherein the weightage factor is based on image resolution of the transformed image; and
constructing a resultant image of the planar surface of the object using each transformed image and the security map for the transformed image, to identify the object.

The present disclosure is of advantage in that it provides an at least partial solution to a problem of identifying an object using at least one imaging device, wherein identifying an object primarily includes generating a resultant image of the object from image of a planar surface of the object and wherein the at least one imaging device is arranged substantially perpendicular to a planar surface of the object; identifying the object is made more accurate or efficient by associating parameters, described herein later.

Optionally, the substantially perpendicular is in a range of 70° to 110°.

Optionally, wherein the calibration information for each of the at least one imaging device comprises at least one of: position of the at least one imaging device with respect to the object, functional parameters of the at least one imaging device.

Optionally, the method further comprises generating the calibration information for each of the at least one imaging device.

Optionally, the method further comprises generating a warp map using the calibration information for each of the at least one imaging device, wherein the warp map is associated with a transformation matrix.

Optionally, the weightage factor is calculated as an inverse of a distance of the pixel, from at least one pixel positioned near the pixel in the transformed image.

Optionally, the method further comprises normalizing the at least one transformed image using a local mean intensity technique.

Optionally, the method further comprises determining an error associated with change in position of the at least one imaging device with respect to the object, wherein the error is determined based on a difference in relative location of at least one of: a key-point, and/or a reference item in the transformed images.

Optionally, the method further comprises modifying the transformed image to compensate for the determined error. More optionally, the method further comprises adjusting the position of the at least one imaging device based on the determined error.

Optionally, the planar surface is a side of a log. More optionally, the at least one imaging device is operatively coupled to a head of a forest harvester.

In a second aspect, an embodiment of the present disclosure provides an arrangement for identifying an object, wherein the arrangement comprises:
at least one imaging device arranged substantially perpendicular to a planar surface of the object; and
a data processing apparatus operatively coupled to the at least one imaging device, wherein the data processing apparatus is operable to:
   acquire calibration information for each of the at least one imaging device arranged substantially perpendicular to the planar surface of the object;
   capture an image of the planar surface of the object using each of the at least one imaging device;
   generate a transformed image corresponding to each image of the planar surface of the object, using the calibration information of the at least one imaging device used for capturing each image;
   generate a security map for each transformed image, wherein the security map comprises a weightage factor for each pixel of the transformed image, and wherein the weightage factor is based on image resolution of the transformed image;
   construct a resultant image of the planar surface of the object using each transformed image and the security map for the transformed image; and
   identify the object using the resultant image of the planar surface of the object.

Optionally, the substantially perpendicular is in a range of 70° to 110°.

Optionally, the calibration information for each of the at least one imaging device comprises at least one of: position of the at least one imaging device with respect to the object, functional parameters of the at least one imaging device.

Optionally, the at least one imaging device is a high-resolution digital camera.

Optionally, the data processing apparatus is further operable to generate the calibration information for each of the at least one imaging device.

Optionally, the data processing apparatus is further operable to generate a warp map using the calibration information for each of the at least one imaging device, wherein the warp map is associated with a transformation matrix.

Optionally, the data processing apparatus is operable to calculate the weightage factor as an inverse of a distance of the pixel, from at least one pixel positioned near the pixel in the transformed image.

Optionally, the data processing apparatus is further operable to normalize the at least one transformed image using a local mean intensity technique.

Optionally, the data processing apparatus is further operable to determine an error associated with change in position of the at least one imaging device with respect to the object, wherein the error is determined based on a difference in relative location of at least one of: a key-point, and/or a reference item in the transformed images.

Optionally, the data processing apparatus is further operable to modify the transformed image to compensate for the determined error. More optionally, the data processing apparatus is further operable to adjust the position of the at least one imaging device based on the determined error.

Optionally, the planar surface is a side of a log. More optionally, the at least one imaging device is mounted on a head of a forest harvester.

In a third aspect, an embodiment of the present disclosure provides a system for identifying a log, wherein the system comprises:
a forest harvester;
at least one imaging device coupled to the forest harvester, wherein the at least one imaging device is mounted on a head of the forest harvester; and
a data processing apparatus operatively coupled to the at least one imaging device, wherein the data processing apparatus is operable to:
   acquire calibration information for each of at least one imaging device arranged substantially perpendicular to a side of the log;
   capture an image of the side of the log using each of the at least one imaging device;
   generate a transformed image corresponding to each image of the side of the log, using the calibration information of the at least one imaging device used for capturing each image;
   generate a security map for each transformed image, wherein the security map comprises a weightage factor for each pixel of the transformed image, and wherein the weightage factor is based on image resolution of the transformed image;
   construct a resultant image of the side of the log using each transformed image and the security map for the transformed image; and
   identify the log using the resultant image of the side of the log.

Optionally, the system further comprises at least one hinge assembly, wherein each of the at least one imaging device is mounted on the head of the forest harvester using the at least one hinge assembly. Moreover, the system further comprises at least one actuator assembly operatively coupled to the at least one imaging device, wherein the at least one actuator assembly is operable to modify a position of the at least one imaging device.

Optionally, the data processing apparatus is further operable to transmit a signal to the at least one actuator assembly to modify the position of the at least one imaging device.

Optionally, the system further comprises at least one vibration damping assembly operatively coupled to the at least one imaging device.

Optionally, the system further comprises a server arrangement communicatively coupled to the data processing apparatus, wherein the data processing apparatus is operable to transmit the resultant image of the side of the log to the server arrangement.

The method and the arrangement enable identification of an object using the at least one imaging device arranged substantially perpendicular to the planar surface of the object. Such a method and arrangement enable identification of the object when the imaging device cannot be arranged parallel to the object (such as, in front or rear of the object). Furthermore, the arrangement employs calibration information of the at least one imaging device for generating the transformed image, thereby enabling use of different imaging devices (such as, imaging devices having different functional parameters) within the arrangement. Moreover, the method and the arrangement enable to construct the resultant image while considering a quality (such as image resolution) of the transformed image. Such a construction of the resultant image by considering the quality of the transformed image enables to generate the resultant image having high quality (such as high detail of the planar surface of the object reflected therein), thereby enabling easier identification of the planar surface of the object from the resultant image. Furthermore, the arrangement can be implemented in a system for identifying a log, to identify various logs while they are being harvested by a forest harvester. Such a system enables to overcome various drawbacks associated with conventional systems for identifying logs during harvesting thereof, such as, drawbacks associated with artifacts (such as movement artifacts, lighting artifacts, and so forth) that can get introduced into the images captured during the harvesting operation. Moreover, the system can be used to re-identify the log at a later stage of value chain of the log, such as, during storage or processing thereof in a sawmill. Such re-identification of the log enables improved management (such as storage, use and so forth) and traceability through the entire value chain of the log.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is an illustration of steps of a method of identifying an object using at least one imaging device, in accordance with an embodiment of the present disclosure;

FIG. 2 is a block diagram of an arrangement for identifying an object, in accordance with an embodiment of the present disclosure;

FIG. 3 is a block diagram of a system for identifying a log, in accordance with an embodiment of the present disclosure;

FIG. 4 is a block diagram of an exemplary implementation of the system of FIG. 3, in accordance with an embodiment of the present disclosure;

FIG. 5 is a perspective view of the arrangement for capturing image, in accordance with an embodiment of the present disclosure; and

FIG. 6 is a perspective view of the position of the imaging device of FIG. 5 on a head of a forest harvester for capturing image of a planner portion of the log, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In a first aspect, an embodiment of the present disclosure provides a method of identifying an object using at least one imaging device, wherein the method comprises:
acquiring calibration information for each of the at least one imaging device arranged substantially perpendicular to a planar surface of the object;
capturing an image of the planar surface of the object using each of the at least one imaging device;
generating a transformed image corresponding to each image of the planar surface of the object, using the calibration information of the at least one imaging device used for capturing each image;
generating a security map for each transformed image, wherein the security map comprises a weightage factor for each pixel of the transformed image, and wherein the weightage factor is based on image resolution of the transformed image; and
constructing a resultant image of the planar surface of the object using each transformed image and the security map for the transformed image, to identify the object.

In a second aspect, an embodiment of the present disclosure provides an arrangement for identifying an object, wherein the arrangement comprises:
at least one imaging device arranged substantially perpendicular to a planar surface of the object; and
a data processing apparatus operatively coupled to the at least one imaging device, wherein the data processing apparatus is operable to:
   acquire calibration information for each of the at least one imaging device arranged substantially perpendicular to the planar surface of the object;
   capture an image of the planar surface of the object using each of the at least one imaging device;
   generate a transformed image corresponding to each image of the planar surface of the object, using the calibration information of the at least one imaging device used for capturing each image;
   generate a security map for each transformed image, wherein the security map comprises a weightage factor for each pixel of the transformed image, and wherein the weightage factor is based on image resolution of the transformed image;
   construct a resultant image of the planar surface of the object using each transformed image and the security map for the transformed image; and
   identify the object using the resultant image of the planar surface of the object.

In a third aspect, an embodiment of the present disclosure provides a system for identifying a log, wherein the system comprises:
a forest harvester;
at least one imaging device coupled to the forest harvester, wherein the at least one imaging device is mounted on a head of the forest harvester; and
a data processing apparatus operatively coupled to the at least one imaging device, wherein the data processing apparatus is operable to:
   acquire calibration information for each of at least one imaging device arranged substantially perpendicular to a side of the log;
   capture an image of the side of the log using each of the at least one imaging device;
   generate a transformed image corresponding to each image of the side of the log, using the calibration information of the at least one imaging device used for capturing each image;
   generate a security map for each transformed image, wherein the security map comprises a weightage factor for each pixel of the transformed image, and wherein the weightage factor is based on image resolution of the transformed image;
   construct a resultant image of the side of the log using each transformed image and the security map for the transformed image; and
   identify the log using the resultant image of the side of the log.

The arrangement for identifying the object relates to a structure including one or more programmable and/or non-programmable components that are configured to perform one or more steps to identify the object. Optionally, the structure including the programmable and/or non-programmable components are arranged in a manner to form a computing environment that is configured to capture information related to the object, store information related to identification of the object, and subsequently process and/or share information therein. Furthermore, information related to the identification of the object includes data depicting the distinctiveness of the object. Additionally, an arrangement allows seamless identification of the object. Furthermore, the identification information of the object can be used for managing the object in a value chain of the object. Optionally, the arrangement can be used to identify a log (lumber). Furthermore, the arrangement can be implemented as a structure coupled to a forest harvester cropping the log.

The arrangement comprises the at least one imaging device arranged substantially perpendicular to the planar surface of the object. Throughout the present disclosure, the term “at least one imaging device” relates to a device that includes at least one lens and image sensor to acquire a reflectance from a reflected visible light that is reflected from the planar surface of the object. In an example, the at least one imaging device is implemented using a uEye LE USB 3.1 Gen. 1 camera. Optionally, the at least one imaging device is mounted on a head of the forest harvester. The at least one imaging device is mounted on the head of the forest harvester in a manner such that the imaging device is capable of capturing a side view of the object. Optionally, the at least one imaging device is mounted inside of a protective housing to prevent contact of the chain saw with the imaging device that may result in damage thereof.

Optionally, the arrangement further comprises at least one hinge assembly, wherein each of the at least one imaging device is mounted on the head of the forest harvester using the at least one hinge assembly. Optionally, the hinge assembly is coupled to a connecting portion (such as connecting portion) of the protective housing. The hinge assembly includes a base member (such as a mounting plate) and a plurality of hinge members. Optionally, the hinge member is movably coupled to a base member by attaching a first pin (such as a shear pin) into a first set of adjustment holes. Furthermore, the hinge member is movably coupled to the hinge member by attaching a second pin (such as a shear pin) into a second set of adjustment holes. Such an attachment of the first pin into the first set of adjustment holes provides a single (or multiple) degrees of freedom to the hinge member about the base member. Similarly, attachment of the second pin into the second set of adjustment holes provides a single (or multiple) degrees of freedom to the hinge member about the hinge member. For example, when the first set of adjustment holes comprise 4 holes and the second set of adjustment holes comprise 5 holes; the imaging device has 20 degrees of freedom about the base member.

Optionally, the arrangement further comprises at least one actuator assembly operatively coupled to the at least one imaging device. The at least one actuator assembly comprises controllable elements that may be operatively coupled with the at least one imaging device. For example, the actuator assembly comprises at least one of a hydraulic or a pneumatic actuator that is operable to change a position and/or an angular orientation of the at least one imaging device.

Optionally, the at least one actuator assembly is operable to modify a position of the at least one imaging device. Alternatively, the actuator assembly is operable to change the angular orientation of the at least one imaging device, such as, by rotating the at least one imaging device with respect to an initial angular orientation thereof.

Optionally, arrangement further comprises at least one vibration damping assembly operatively coupled to the at least one imaging device. The vibration damping assembly, is operatively coupled to the at least one hinge assembly that is used for mounting the at least one imaging device on the head of the forest harvester. Optionally, the vibration damping assembly includes, but not limited to, devices that counteract, control or reduce the vibrations of a vibrating element but also devices such as isolators that insulate or protect elements that are associated with a vibrating element, such the head of the forest harvester.

Optionally, the at least one imaging device is mounted fixedly or retractably onto the head of the forest harvester. Optionally, the at least one imaging device can be mounted fixedly using a suitable mechanical coupling arrangement, such as brackets, screws and the likes.

The at least one imaging device is operable to capture the at least one image at an orthogonal angle, namely not at an oblique angle to an elongate axis of the object (log) or the surface of the object that is being imaged. The at least one imaging device is held or arranged perpendicularly (orthogonally) for taking orthogonal images of the planar surface of the object, such as the side of the log. Optionally, the at least one imaging device is operable to capture image of the side of the object, when held orthogonally with respect to the at least one imaging device coupled to the forest harvester. In an example, the object such as the log may be held by an arm of the forest harvester for chopping. In such an instance, the at least one imaging device coupled to the forest harvester is configured to capture an image of a surface of the log that is substantially perpendicular to the at least one imaging device. It is to be understood that the surface of the log and the at least one imaging device (i.e. a face of imaging device including a lens assembly) form an angle substantially equal to 90°.

Optionally, the substantially perpendicular is in a range of 70° to 110°, i.e. the at least one imaging device and the planar surface of the object form an angle within the range of 70° to 110°. Optionally, the at least one imaging device and the planar surface of the object form an angle within the range of 80° to 100°. More optionally, the at least one imaging device and the planar surface of the object form an angle within the range of 85° to 95°. Optionally, the at least one imaging device and the planar surface of the object can form an angle of 87°.

Optionally, the arrangement comprises more than one imaging device arranged in different position along the head of the forest harvester. The imaging device arranged in different positions is configured to capture orthogonal images of the planar surface of the object from respective positions. Furthermore, using more than one imaging device improves a mean time between failure (or MBTF) of the arrangement, as at least one imaging device will continue to operate if another imaging device fails during operation of the arrangement. Optionally, the arrangement comprises one imaging device arranged on the head of the forest harvester that can be maneuvered to capture orthogonal images of the planar surface of the object from different positions. In such an instance, it will be appreciated that the person operating the forest harvester may include sufficient knowledge for using the forest harvester and the components associated therein.

The arrangement comprises the data processing apparatus operatively coupled to the at least one imaging device. Throughout the present disclosure, the term “data processing apparatus” relates to programmable and/or non-programmable components configured to execute one or more software application for storing, processing and/or sharing data and/or set of instruction. Optionally, the data processing apparatus can include, for example, a component included within an electronic communications network. Additionally, the data processing apparatus can include one or more data processing facilities for storing, processing and/or sharing data and/or set of instruction. Optionally, the data processing arrangement includes functional components, for example, a processor, a memory, a network adapter and so forth. Furthermore, the data processing apparatus includes hardware, software, firmware or a combination of these, suitable for storing and processing information and providing services. For example, the data processing apparatus may be configured to store information such as images of the planar surface of the object and process the images of the object to reconstruct an image that may be used for services such as identification and re-identification of the object, such as the log (lumber).

The data processing apparatus is operatively coupled to the at least one imaging device. Optionally, the data processing apparatus includes a communication module that is operable to transmit signals for controlling the operation of the at least one imaging device. Optionally, the communication module provides a wired or wireless interface between the data processing apparatus and the at least one imaging device. In an example, the communication module may include a fiber optic assembly for providing the interface between the data processing apparatus and the imaging device. In another example, the wireless interface between the data processing apparatus and the at least one imaging device includes, but is not limited to a Low-Power Wide-Area Network (LPWAN) or other wireless area network technology, such as wireless personal area network technology. In such example, wireless personal area network technology may include INSTEON®, IrDA®, Wireless USB®, Bluetooth®, Bluetooth Low Energy (BLE), Z-Wave®, Zig Bee®, Body Area Network and so forth.

The data processing apparatus is operable to acquire calibration information for each of the at least one imaging device arranged substantially perpendicular to the planar surface of the object. The data processing apparatus acquires calibration information for each of the imaging devices via the communication module. Optionally, the data processing apparatus is further operable to generate the calibration information for each of the at least one imaging device. For example, the data processing apparatus is operable to generate the calibration information during a setup phase (such as, prior to commencing operation) of the arrangement for identifying the object. In such an example, a test object (that can be similar or same as the object) can be arranged on the object plane. Subsequently, a reference image of a planar surface of the test object is captured, such as, by arranging a test imaging device (that can be same as the at least one imaging device) facing towards the planar surface of the test object, to capture the reference image. Thereafter, an image of the planar surface of the object is captured using each of the at least one imaging device. Subsequently, a transformed image is generated corresponding to each captured image of the planar surface of the test object. Such transformed images of the planar surface of the test object are compared with the reference image, to generate the calibration information for each of the at least one imaging device. For example, a difference in size of the planar surface of the test object in the transformed image as compared to the reference image, enables to determine the position of the at least one imaging device in space, such as a distance with respect to position of the test imaging device in space. Furthermore, such a position of the at least one imaging device is used to determine the pixel-coordinate of each pixel of the image captured by each of the at least one imaging device, with respect to pixel-coordinates of corresponding pixels of the reference image. Such determined pixel-coordinates enables to determine an amount of change (such as translation, increase or decrease in size, and so forth) that each pixel of the image captured by each of the at least one imaging device is required to be subjected to, to obtain a corresponding pixel of the reference image. In another example, a difference in angular orientation of the planar surface of the test object in the transformed image as compared to the reference image, enables to determine an angular orientation of the at least one imaging device in space (such as an angular orientation with respect to a position of the test imaging device). Furthermore, the angular orientation can be used to determine an amount of rotation that each pixel of the image captured by each of the at least one imaging device is required to be subjected to, to obtain a corresponding pixel of the reference image.

Optionally, the calibration information for each of the at least one imaging device comprises at least one of position of the at least one imaging device with respect to the object, and/or functional parameters of the at least one imaging device. For example, the calibration information for each of at least one imaging device comprises position of the at least one imaging device with respect to the object, such as a distance, an angular orientation and so forth. Such a position is reflected in an image of the object that is captured by each of the at least one imaging device.

Furthermore, the position can be represented by a pixel-coordinate of each pixel of the image of the object that is captured by each of the at least one imaging device, such as, with respect to pixel-coordinates of corresponding pixels of the reference image of the object (such as, an image that is captured by arrangement of an imaging device directly facing the planar surface of the object). Moreover, the position of each of the at least one imaging device can be determined with respect to a surface (or plane) where the object is arranged for capturing the image thereof. Such a surface has been referred to as “object plane” throughout the present disclosure. The calibration information may also comprise functional parameters of the at least one imaging device, including but not limited to, power of a lens used in the imaging device, a lens distortion function of the lens used in the imaging device, a standard resolution of the images captured by the imaging device and so forth.

Optionally, the data processing apparatus is operable to store the individual calibration information associated with each of the at least one imaging device. Subsequently, the data processing apparatus is operable to process the images captured by each of the at least one imaging device based on the individual calibration information associated therein. Optionally, the data processing apparatus is configured to acquire calibration information for each of the at least one imaging device after a specific time interval and/or upon determining an error in the captured image of the at least one imaging device.

Optionally, the data processing apparatus is further operable to generate a warp map using the calibration information for each of the at least one imaging device, wherein the warp map is associated with a transformation matrix. The term “warp map” as used herein, relates to a systematically arranged collection of information. The warp map can comprise a plurality of cells arranged in rows and columns, wherein each cell is used to store specific information related to each pixel of an image. In one example, when the image has an image resolution of 800×600 pixels, the warp map comprises 480,000 cells. In such an example, the cells are operable to store calibration information (such as pixel-coordinate) corresponding to each pixel of the image, captured by each of the at least one imaging device. For example, when the calibration information comprises the amount of change and/or the amount of rotation for each pixel, numerical values corresponding to the calibration information is stored in each cell of the warp map (for example, as comma separated values). Optionally, the generated warp map can store a reoriented pixel-coordinate for each pixel of the image that is captured by each of the at least one imaging device. Such a reoriented pixel-coordinate for each pixel can be determined mathematically as:

(xᵢ′,yⱼ′)=f_{d}(M×(xᵢ,yⱼ)) Eq. (1)

where (xᵢ′,yⱼ′) represents the reoriented pixel-coordinate for each pixel depicted using a Cartesian coordinate system, f_{d} is a lens distortion function associated with the lens used in each of the at least one imaging device, M is a transformation matrix for each of the at least one imaging device and (xᵢ,yᵢ) is a source pixel-coordinate of each pixel in the image captured by each of the at least one imaging device. Furthermore, the lens distortion function (f_{d}) provides information about an amount of distortion suffered by the captured image due to lens parameters of the lens used in the imaging device. Moreover, the transformation matrix (M) is a matrix of numerical values that can be multiplied with the pixel-coordinate of each pixel in the image to alter (or transform) the pixel-coordinate. Alternatively, the transformation matrix comprises the calibration information (such as the amount of change and/or the amount of rotation) corresponding to each pixel of the image captured by each of the at least one imaging device, stored in a matrix form.

Optionally, the data processing apparatus can be implemented in manners that enable the person operating the forest harvester to provide the calibration information for each of the at least one imaging device. In such an instance, the person operating the forest harvester provides the calibration information via input device coupled to the data processing apparatus. In an example, the input device may be a display screen of the carputer including the data processing apparatus. In such an instance, the display screen may include a virtual keyboard that may be used by the person operating the forest harvester to input the calibration information of each of the imaging device.

The data processing apparatus is operable to capture an image of the planar surface of the object using each of the at least one imaging device.

The at least one imaging device is configured to capture the image of the planar surface of the object and subsequently provide the data processing apparatus with captured image for further storing and processing. Furthermore, the data processing apparatus uses the at least one imaging device to capture orthogonal images of the planar surface of the object. Optionally, the data processing apparatus is capable of controlling and manoeuvring each of the at least one imaging device for capturing appropriate image of the planar surface. For example, the data processing apparatus may be configured to adjust the optical setting, such as optical zoom, aperture, shutter speed, focus and the likes, of the at least one imaging device. In another example, the data processing apparatus may be configured to adjust the orientation of the at least one imaging device, such as the direction of the face of imaging device including the lens assembly.

Optionally, each of the at least one imaging device is configured to capture the at least one image associated with a different focal length. Furthermore, each of the at least one imaging device can comprise a different lens for capturing the at least one image associated with different focal lengths. Specifically, the data processing apparatus implements a digital image processing technique (namely, focus stacking) that combines plurality of the images associated with different focus lengths to give the resultant image with a greater depth of field (or DOF) than any of the plurality of the images captured by the plurality of imaging devices. Beneficially, the aforementioned digital image processing technique can be used in any situation where individual images captured by a given imaging device have a very shallow depth of field, such as in macro photography and optical microscopy. Furthermore, getting sufficient depth of field can be particularly challenging while capturing image from the head of a forest harvester, because depth of field can be smaller (shallower) for objects nearer to the imaging device, so if a small object fills the frame, it is often so close that its entire depth cannot be in focus at once. The depth of field is normally increased by stopping down aperture (using a larger focus number), but beyond a certain point, stopping down causes blurring due to diffraction, which counteracts the benefit of being in focus. Additionally, the aforementioned digital image processing technique enables the depth of field of images taken at the sharpest aperture to be effectively increased. For example, when the at least one imaging device comprises three imaging devices, a first imaging device comprises a wide-angle lens, a second imaging device comprises a telephoto lens and a third imaging device comprises a regular lens. In such an example, the resultant image of the object (described in detail herein later) that is obtained using the at least one image captured by the at least one imaging device, is associated with improved focal depth as compared to a resultant image that is obtained using the at least one imaging device when each of the at least one image has a same lens. More optionally, the lens corresponding to the at least one imaging device is a shift-and-tilt lens that enables to improve the focal depth and resolution associated with the captured at least one image.

Optionally, an imaging device of the at least one imaging device is configured to capture a black-and-white image, another imaging device of the at least one imaging device is configured to capture a colour image, yet another imaging device is configured to capture a coloured image with a higher hue value, and the like. It will be appreciated that the captured black-and-white image will present higher details of the object and the captured colour image will present natural colours associated with the object. Consequently, the resultant image of the object that is obtained using such black-and-white and colour image correspond to improved colour accuracy and higher details as compared to a resultant image that is obtained using only colour images (or only black-and-white images). Optionally, the data processing apparatus can include a software program, algorithm or routine that is configured to analyse the sharpness in different types of the plurality of images, and subsequently develop the image of the planar surface of the object having a greater depth of field to have a greater sharpness than any of the plurality of the images captured by the plurality of imaging devices. In an example, one image of the plurality of images may be a black and white image having greater sharpness of image as compared to another image of the plurality of images that is a coloured image. In such an instance, the software program, algorithm or routine is configured to select the sharpness of image included in the black and white image of the planar surface of the object, and subsequently develop the image of the planar surface of the object having greater depth of field.

Optionally, the at least one imaging device is a dual lens camera. Furthermore, an image captured using such a dual lens camera provides improved information associated with depth of the object. Such information associated with the depth of the object can be employed for determining a circumference of the object, a diameter of the object, a cut surface of the object and so forth.

Optionally, the at least one imaging device is a controllable camera that is provided with an auto-focus functionality. For example, such a controllable camera can be configured to capture two or more images in quick succession, capture two or more images associated with different focal depths and so forth. It will be appreciated that such a controllable camera enables to capture an increased number of images as compared to a regular camera. Furthermore, such a controllable camera can capture images associated with different parameters (such as different focal depths), thereby, reducing a requirement for using multiple imaging devices within the arrangement.

The data processing apparatus is operable to generate a transformed image corresponding to each image of the planar surface of the object, using the calibration information of the at least one imaging device used for capturing each image. It will be appreciated that each image of the planar surface of the object captured using the at least one imaging device may represent a different perspective of the planar surface of the object, based on arrangement of the imaging device. Furthermore, when each of the at least one imaging device is associated with different functional parameters (such as different lens parameters of lens used in each of the at least one imaging device), the image captured by each of the at least one imaging device will be different from each other. In such an instance, the data processing apparatus is operable to generate a transformed image corresponding to each image of the planar surface of the object, such that each transformed image represents a same perspective of the planar surface of the object. Furthermore, the data processing apparatus is operable to use the calibration information of the at least one imaging device used for capturing each image, to generate the transformed image.

The data processing apparatus is operable to generate a security map for each transformed image, wherein the security map comprises a weightage factor for each pixel of the transformed image, and wherein the weightage factor is based on image resolution of the transformed image. The term “security map” as used herein, relates to a systematically arranged collection of information. The security map can comprise a plurality of cells arranged in rows and columns, wherein each cell is used to store specific information related to each pixel of the transformed image. In an example, when the transformed image has the image resolution of 1920×1080 pixels, the security map comprises 2,073,600 cells. In another example, the security map can comprise a visual representation of the information, such as a chart or a diagram. Furthermore, the security map is operable to store the weightage factor for each pixel of the transformed image. For example, the weightage factor for each pixel can be indicated by a numerical value, such as a value less than or equal to 1, as a percentage value or visually (such as, when the security map is a chart, the weightage factor can be indicated using dots of different colour gradients for each pixel, based on the weightage factor thereof). Furthermore, when the weightage factor of each pixel of the transformed image is indicated by the numerical value or as the percentage value, the weightage factor is stored in a cell corresponding to the pixel in the security map.

The term “weightage factor” as used herein, relates to an importance of each pixel of the transformed image, within the resultant image (described in detail herein later). Optionally, a common weightage factor may be associated with all of the pixels of a transformed image, but different weightage factors for each transformed image, in order to simply weight a collection of transformed images to provide the resultant image. Alternatively, the transformed image may have different weightage factors for the different pixels of the transformed image. The pixel of the transformed image having a higher weightage factor will be considered more prominently for constructing the resultant image. Furthermore, the weightage factor is based on the image resolution of the transformed image. For example, while capturing the image of the planar surface of the object by each of the at least one imaging device, various artefacts may get introduced into the image captured by each of the at least one imaging device (such as movement artefacts, noise, artefacts due to varying light intensity and so forth). Furthermore, based on arrangement of each of the at least one imaging device, a different amount of artefacts may get introduced into each image. Moreover, while generating the transformed image corresponding to each image of the planar surface of the object, the pixels of each of the transformed image may be required to be subjected to different amount of change (such as, change in size of the pixels) such that each of the transformed images may have different pixels-per-inch (or PPI) of the image. The introduction of such artefacts and/or change in each image may cause the images to have different image resolutions as compared to each other. It will be appreciated that, such an image resolution of each image reflects a quality (or clarity) thereof, such as, an image with higher image resolution with be associated with higher image quality as compared to an image with lower image resolution. Alternatively, use of the at least one imaging device having different functional parameters, may cause the images to have different image resolutions. In such instances, the weightage factor for each pixel of the transformed image is calculated based on the image resolution of the corresponding transformed image.

Optionally, the data processing apparatus is operable to calculate the weightage factor as an inverse of a distance of the pixel, from at least one pixel positioned near the pixel in the transformed image. For example, when the pixel is located at a corner of the transformed image, the weightage factor for the pixel may be determined based on a distance thereof from at least one pixel located around the pixel on three sides thereof. In another example, when the pixel is located near a centre of the transformed image, the weightage factor for the pixel may be determined based on a distance from at least one pixel located in immediate vicinity thereof. Advantageously, the pixel positioned near the pixel in the transformed image is the nearest pixel. For example, when a location of each pixel of the transformed image is represented on a Cartesian coordinate system, a first pixel can be located at a position P(x₁′,y₁′). Furthermore, a second pixel nearest the first pixel can be located at a position Q(x₂′,y₂′). In such an instance, the weightage factor for the first pixel can be determined mathematically as:

$$S ( {x}_{1}^{′} , {y}_{1}^{′} ) = \frac{1}{\sqrt{( {y}_{2}^{′} - {y}_{1}^{′} ) + {( {x}_{2}^{′} - {x}_{1}^{′} )}^{2}}} \qquad Eq . ( 2 )$$

A software routine that maximizes S(x₁′,y₁′) may be applied to find the nearest pixel, Q, by looking for the smallest values of y₂′−y₁′ and x₂′−x₁′. Typically, the nearest pixel will have an adjacent index, i or j, in equation 1. Furthermore, the weightage factor of the pixel is indicative of the image resolution of the transformed image comprising the pixel and consequently, an importance of the transformed image corresponding to the pixel within the resultant image. In one example, a pixel in a transformed image is located at a distance of 10 arb. units from a nearest pixel. In such an example, the weightage factor of the pixel will be 0.1. Furthermore, another pixel in the transformed image is located at a distance of 100 arb. units from a nearest pixel. In such an example, the weightage factor of the pixel will be 0.01. It will be appreciated that the transformed image in the vicinity of the pixel located at the distance of 10 arb. units from the nearest pixel, will have a higher resolution as compared to the transformed image in the vicinity of the pixel located at the distance of 100 arb. units from the nearest pixel. In such an instance, the pixel located at the distance of 10 arb. units will be associated with the higher weightage factor of 0.1 as compared to the pixel located at the distance of 100 arb. units that will be associated with the lower weightage factor of 0.01. Consequently, the pixel will be associated with higher importance for constructing the resultant image, as compared to the importance of the other pixel.

In an alternative embodiment, in which each transformed image has even spacing in both dimensions between the pixels, equation 2 may be applied; but will result in a uniform weightage factor for all pixels of the transformed image.

Optionally, the data processing apparatus is further operable to determine an error associated with change in position of the at least one imaging device with respect to the object. The data processing apparatus is configured to host one or more algorithms for determining the error. Optionally the one or more algorithms are configured to compare the images captured by the at least one imaging device. Furthermore, the comparison includes matching feature detectors and descriptors of the images. Optionally, the matching of feature detectors and descriptors of the images may be performed for blur, illumination and scale changes, rotation and affine transformation determined in the transformed image.

Optionally, the error associated with change in position of the at least one imaging device is determined based on a difference in relative location of a key-point in the transformed images. The key-point in the transformed images refers to a point and/or location in the transformed images that is marked in the transformed images. Furthermore, the data processing apparatus is operable to compare the captured image with the transformed images to match the relative location of the key-point to a relative location of the captured image. Subsequently, in the event wherein the relative location of the key-point is different in the captured image, the data processing apparatus identifies the event as an error.

Optionally, the error associated with change in position of the at least one imaging device is determined based on a difference in relative location of a reference item in the transformed images. The reference item in the transformed images refers to an object and/or item in the transformed images that is recognized in the transformed images. Furthermore, the data processing apparatus is operable to compare the captured image with the transformed images to match the relative location of the reference item to a relative location of the captured image. Subsequently, in the event wherein the relative location of the reference item is different in the captured image, the data processing apparatus identifies the event as an error.

Optionally, the data processing apparatus is further operable to modify the transformed image to compensate for the determined error. The data processing apparatus is configured to consider the determined error while generating the transformed image corresponding to each image of the planar surface of the object. For example, the difference in relative location of the key-point and/or the reference item is associated with a linear movement and/or rotation of the at least one imaging device with respect to an initial location thereof, the data processing apparatus is operable to determine the error based on the difference. In such instance, the data processing apparatus is operable to modify the transformed image to compensate for the determined error caused by the linear movement and/or rotation of the at least one imaging device.

Optionally, the data processing apparatus is further operable to adjust the position of the at least one imaging device based on the determined error. The data processing apparatus is configured to use the difference in relative location of the key-point and/or the reference item in the transformed images to determine the amount of adjustment required to the position of the at least one imaging device. For example, in the event wherein the difference in relative location of the key-point and/or the reference is 5 cm, then the data processing apparatus is configured to rearrange the at least one imaging device to location to cancel out the relative location of the key-point and/or the reference item.

The data processing apparatus is operable to construct a resultant image of the planar surface of the object using each transformed image and the security map for the transformed image. The term “resultant image” as used herein, relates to an image that enables identification of the object therefrom. Such a resultant image can be an image of the planar surface of the object from a front (or a top) thereof, such as, an image of the object that is captured by arranging an imaging device directly in front of the object (or above the object). Furthermore, the resultant image enables to establish an identity of the object, such that, the resultant image can be used to uniquely identify the object.

The resultant image can be constructed by combining the various transformed images of the planar surface of the object. Such a combination of the transformed images can be performed by superimposing corresponding pixels of the transformed images, to construct the resultant image. Optionally, the resultant image can be constructed by calculating a weighted average of the corresponding pixels of the transformed images, using the weightage factors of the pixels as weights, to obtain the various pixels of the resultant image.

Mathematically, such an operation of calculating the weighted average can be expressed as:

$$J ( {x}_{j} , {y}_{j} ) = [ \frac{{\sum }_{1}^{n} {s}_{n} ( {x}_{j}^{′} , {y}_{j}^{′} ) \text{?} ( {x}_{j}^{′} , {y}_{j}^{′} )}{{\sum }_{1}^{n} {s}_{n} ( {x}_{\text{?}} , {y}_{j} )} ] \\ \text{?} \text{indicates text missing or illegible when filed} \qquad Eq . ( 3 )$$

where Jₙ represents the pixels of the resultant image, In represents the pixels of the transformed images corresponding to the pixels of the resultant image, Sₙ represents the weightage factor of the pixels of the transformed image (calculated using Eq. (2) as described hereinabove), n is a number of transformed images that are used for creating the resultant image, i is a position of a pixel along x-axis (abscissa or horizontal direction) in the corresponding transformed image and j is a position of the pixel along y-axis (ordinate or vertical direction) in the corresponding transformed image. It will be appreciated that such a construction of the resultant image by using Eq. (3) provides more consideration (by using higher weightage factor of pixels) to the transformed images having high resolution and less consideration (by using lower weightage factor of pixels) to the transformed images with low resolution. Consequently, the resultant image will be associated with high clarity, thereby, enabling easier identification of the planar surface of the object therefrom.

Optionally, the data processing apparatus is further operable to determine at least one feature of the planar surface of the object from the resultant image. For example, the data processing apparatus is operable to employ a feature detection operator in an algorithm such as, BRISK (Binary Robust Invariant Scalable Keypoints), BRIEF (Binary Robust Independent Elementary Features), FAST (Features from Accelerated Segment Test), Harris Corner Detector, MSER (Maximally Stable Extremal Regions), ORB (Oriented Fast and Rotated BRIEF), SIFT (Scale-Invariant Feature Transform), SURF (Speeded-Up Robust Features) and so forth, to extract at least one feature of the planar surface of the object from the resultant image. Such an at least one feature of the planar surface of the object may be associated with specific constraints, such as, chirality (such that the at least one feature enables non-mirrored transformation thereof along a plane).

Optionally, the data processing apparatus is further operable to normalize the at least one transformed image using a local mean intensity technique. The transformed images are normalized (or enhanced) such that each of the transformed images has a substantially similar intensity, using the local mean intensity technique. Furthermore, such a normalization of the transformed images is performed prior to constructing the resultant image. In one example, the local mean intensity technique comprises an adaptive histogram equalization (or AHE) technique. In another example, the local mean intensity technique comprises a local intensity distribution equalization (or LIDE) technique.

The data processing apparatus is operable to identify the object using the resultant image of the planar surface of the object. For example, the data processing apparatus is operable to associate the resultant image of the planar surface of the object, with the at least one feature of the planar surface of the object, to uniquely identify the object. It will be appreciated that the data processing apparatus can distinguish the object (such as a log) from other objects that may be similar to the object (such as, from other logs that are stored together with the log), using the resultant image and optionally, the at least one feature of the planar surface of the object. Optionally, the data processing apparatus is operable to assign a unique identification for the object, wherein the identification can include an alphanumeric string, a code (such as a barcode, a QR code) and so forth for the object.

Optionally, the data processing apparatus is further operable to determine metadata for each object, subsequent to constructing the resultant image for the object. In one example, the metadata comprises a location of the object (such as, a location of harvesting of a log), a weight of the object, dimensions of the object and so forth.

Optionally, the resultant image of the planar surface of the object can be used to re-identify the object at a remote location. For example, when the object is a log that is harvested in a forest (referred to as “harvested log”) using a forest harvester, the harvested log may be transported to a remote location such as a sawmill (referred to as “stored log”, for further processing, storage and so forth. In such an example, the stored log may be required to be re-identified, such as, to determine an origin thereof, an intended use of the stored log, and so forth. The sawmill may comprise a server arrangement that is communicatively coupled to the data processing apparatus, wherein the data processing apparatus is operable to transmit the resultant image of planar surface of the harvested log that is transported to the sawmill, at least one feature of the harvested log and the metadata of the harvested log to the server arrangement. Such a server arrangement can comprise a second data processing apparatus. Furthermore, at least one second imaging device (that can be same as the at least one imaging device) may be arranged at the sawmill for capturing an image of each stored log, such as, prior to processing or storage thereof. Such an at least one second imaging device can be arranged to capture the image of the planar surface of the stored log from a front (or top) thereof, such that, the stored log is clearly distinguishable from other stored logs using the captured image. Optionally, the resultant image of planar surface of the harvested log, at least one feature of the harvested log and the metadata thereof may be stored in a portable data storage device (such as a USB flash drive). Subsequently, the resultant image, the at least one feature and the metadata of the harvested log may be retrieved at the sawmill from the portable data storage device (or from the server arrangement). Thereafter, an image of the stored log is captured using the at least one second imaging device. Optionally, the second data processing apparatus is operable to extract at least one feature from the captured image. Subsequently, the second data processing apparatus is operable to compare the at least one feature of the captured image with the at least one feature of the resultant image. Thereafter, when a number of the at least one feature of the captured image corresponding to a number of the at least one feature of the resultant image is above a predefined threshold, the stored log is re-identified as the harvested log. Alternatively, when the number of the at least one feature of the captured image of the stored log, corresponding to the number of the at least one feature of the resultant image of the harvested log is above the predefined threshold for more than one stored log, the stored logs are ranked based on the number of corresponding features, with a higher number of corresponding features being associated with a higher likelihood of the stored log being re-identified as the harvested log.

Disclosed is a method of identifying an object using at least one imaging device, wherein the method comprises acquiring calibration information for each of the at least one imaging device arranged substantially perpendicular to a planar surface of the object, capturing an image of the planar surface of the object using each of the at least one imaging device, generating a transformed image corresponding to each image of the planar surface of the object, using the calibration information of the at least one imaging device used for capturing each image; generating a security map for each transformed image, wherein the security map comprises a weightage factor for each pixel of the transformed image, and wherein the weightage factor is based on image resolution of the transformed image; and constructing a resultant image of the planar surface of the object using each transformed image and the security map for the transformed image, to identify the object.

Optionally, the substantially perpendicular is in a range of 70° to 110°. Optionally, the calibration information for each of the at least one imaging device comprises at least one of: position of the at least one imaging device with respect to the object, functional parameters of the at least one imaging device. Optionally, the method further comprises generating the calibration information for each of the at least one imaging device. Optionally, the method further comprises generating a warp map using the calibration information for each of the at least one imaging device, wherein the warp map is associated with a transformation matrix. Optionally, the weightage factor is calculated as an inverse of a distance of the pixel, from at least one pixel positioned near the pixel in the transformed image. Optionally, the method further comprises normalizing the at least one transformed image using a local mean intensity technique. Optionally, the method further comprises determining an error associated with change in position of the at least one imaging device with respect to the object, wherein the error is determined based on a difference in relative location of at least one of: a key-point, and/or a reference item in the transformed images. Optionally, the method further comprises modifying the transformed image to compensate for the determined error. Optionally, the method further comprises adjusting the position of the at least one imaging device based on the determined error. Optionally, the planar surface is a side of a log and the at least one imaging device is operatively coupled to a head of a forest harvester.

Moreover, disclosed is a system for identifying a log, wherein the system comprises a forest harvester, at least one imaging device coupled to the forest harvester, wherein the at least one imaging device is mounted on a head of the forest harvester, and a data processing apparatus operatively coupled to the at least one imaging device, wherein the data processing apparatus is operable to acquire calibration information for each of at least one imaging device arranged substantially perpendicular to a side of the log, capture an image of the side of the log using each of the at least one imaging device, generate a transformed image corresponding to each image of the side of the log, using the calibration information of the at least one imaging device used for capturing each image, generate a security map for each transformed image, wherein the security map comprises a weightage factor for each pixel of the transformed image, and wherein the weightage factor is based on image resolution of the transformed image, construct a resultant image of the side of the log using each transformed image and the security map for the transformed image, and identify the log using the resultant image of the side of the log.

Optionally, the system further comprises at least one hinge assembly, wherein each of the at least one imaging device is mounted on the head of the forest harvester using the at least one hinge assembly. Optionally, the system further comprises at least one actuator assembly operatively coupled to the at least one imaging device, wherein the at least one actuator assembly is operable to modify a position of the at least one imaging device. Optionally, the data processing apparatus is further operable to transmit a signal to the at least one actuator assembly to modify the position of the at least one imaging device. Optionally, the system further comprises at least one vibration damping assembly operatively coupled to the at least one imaging device. Optionally, the system further comprises a server arrangement communicatively coupled to the data processing apparatus, wherein the data processing apparatus is operable to transmit the resultant image of the side of the log to the server arrangement.

Optionally, the data processing apparatus is further operable assign digital markers on the at least one image of the planar surface of the object. In an example, the digital markers may be key points on the image of the planar surface of the object. In such example, the key points on the image of the planar surface of the object may be the cuts or bruises that can be formed on the planar surface of the object by the sword of the forest harvester. In one embodiment, the data processing apparatus can receive an image of the planar surface of the object from a third-party hardware (such as a camera of a smart phone of a personal in a saw mall cutting the object, namely the log). In such embodiment, the data processing apparatus can analyse the image provided by the third-party hardware to determine digital markers therein. In such event, wherein the image provided by the third-party hardware has greater number of digital markers then the at least one image of the planar surface of the object captured by the imaging device, the data processing apparatus is configured to store the image of the planner surface having a greater number of digital markers. Optionally, the data processing apparatus can be configured to replace an image of the planner surface of the object already stored in a data repository with the image of the planner surface having a greater number of digital markers.

Optionally, the at least one image of the planar surface of the object captured by the imaging device including the digital markers can be a portion of the planar surface of the object. For example, the portion of the object of the planner surface may be an upper part of the planner surface. In such event the imaging device may be configured to capture plurality of images of the planner surface of the object including digital markers. Beneficially, the data processing apparatus configured to analyse any image provided by the third-party hardware can efficiently analyse the image provided by the third-party hardware with the plurality of images of the planner surface of the object within a lesser amount of time as compared to analysing the image provided by the third-party hardware with a single image of the planner surface of the object.

### DETAILED DESCRIPTION OF THE DRAWINGS

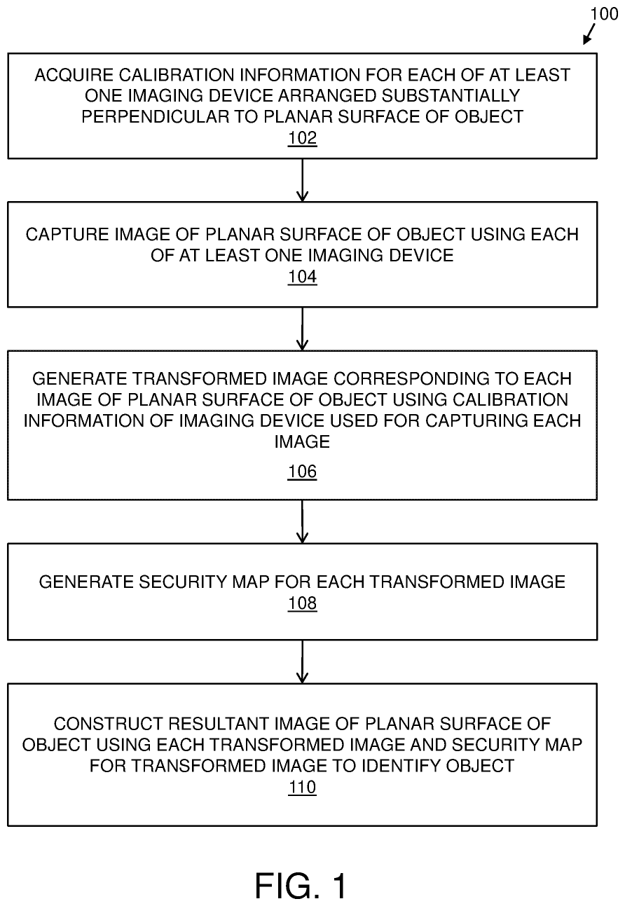

Referring to FIG. 1, there are shown steps of a method 100 of identifying an object using at least one imaging device, in accordance with an embodiment of the present disclosure. At a step 102, calibration information is acquired for each of the at least one imaging device arranged substantially perpendicular to a planar surface of the object. At a step 104, an image of the planar surface of the object is captured using each of the at least one imaging device. At a step 106, a transformed image corresponding to each image of the planar surface of the object is generated, using the calibration information of the at least one imaging device used for capturing each image. At a step 108, a security map is generated for each transformed image, wherein the security map comprises a weightage factor for each pixel of the transformed image, and wherein the weightage factor is based on image resolution of the transformed image. At a step 110, a resultant image of the planar surface of the object is constructed using each transformed image and the security map for the transformed image, to identify the object.

The steps 102 to 110 are only illustrative and other alternatives can also be provided where one or more steps are added, one or more steps are removed, or one or more steps are provided in a different sequence without departing from the scope of the claims herein. In one example, the substantially perpendicular is in a range of 70° to 110°. In another example, the calibration information for each of the at least one imaging device comprises at least one of: position of the at least one imaging device with respect to the object, functional parameters of the at least one imaging device.

In one example, the method 100 further comprises a step of generating the calibration information for each of the at least one imaging device. In another example, the method 100 further comprises generating a warp map using the calibration information for each of the at least one imaging device, wherein the warp map is associated with a transformation matrix.

In an example, the weightage factor is calculated as an inverse of a distance of the pixel, from at least one pixel positioned near the pixel in the transformed image. In another example, the method 100 further comprises normalizing the at least one transformed image using a local mean intensity technique.

In one example, the method 100 further comprises determining an error associated with change in position of the at least one imaging device with respect to the object, wherein the error is determined based on a difference in relative location of at least one of: a key-point, and/or a reference item in the transformed images. In another example, the method 100 further comprises modifying the transformed image to compensate for the determined error.

In an example, the method 100 further comprises adjusting the position of the at least one imaging device based on the determined error. In another example, the planar surface is a side of a log. In yet another example, the at least one imaging device is operatively coupled to a forest harvester.

Referring to FIG. 2, there is shown a block diagram of an arrangement 200 for identifying an object, in accordance with an embodiment of the present disclosure. As shown, the arrangement 200 comprises at least one imaging device 202A-C arranged substantially perpendicular to a planar surface of the object. Furthermore, the arrangement 200 comprises a data processing apparatus 204 operatively coupled to the at least one imaging device 202A-C.

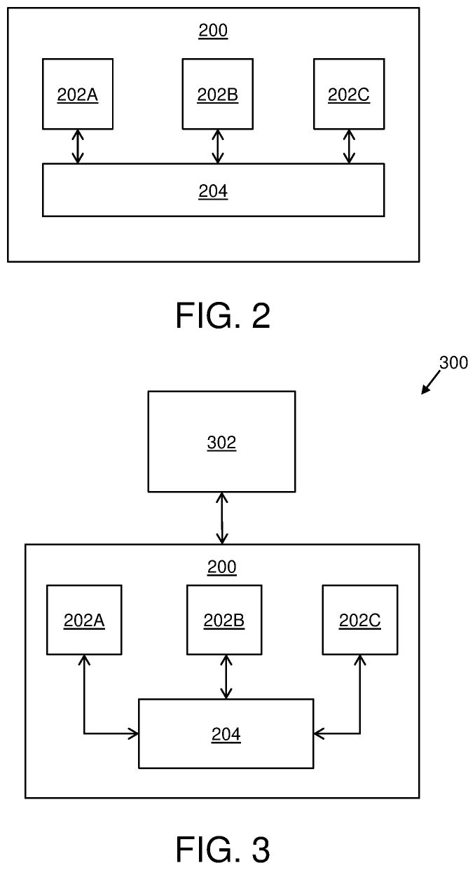

Referring to FIG. 3, there is shown a block diagram of a system 300 for identifying a log, in accordance with an embodiment of the present disclosure. As shown, the system 300 comprises a forest harvester 302. Furthermore, the arrangement 200 of FIG. 2 is operatively coupled to the forest harvester 302.

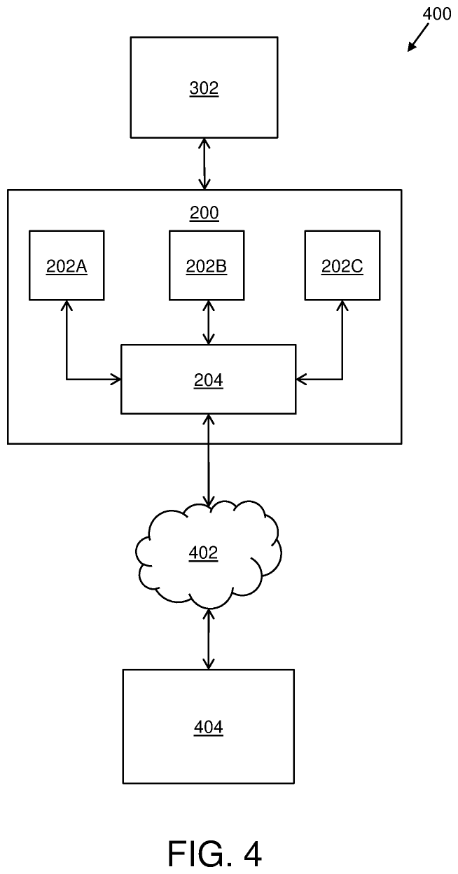

Referring to FIG. 4, there is shown a block diagram of an exemplary implementation 400 of the system 300 of FIG. 3, in accordance with an embodiment of the present disclosure. As shown, the system 300 is communicatively coupled to a server arrangement 404 via a wireless communication network 402 (implemented as a cloud network).

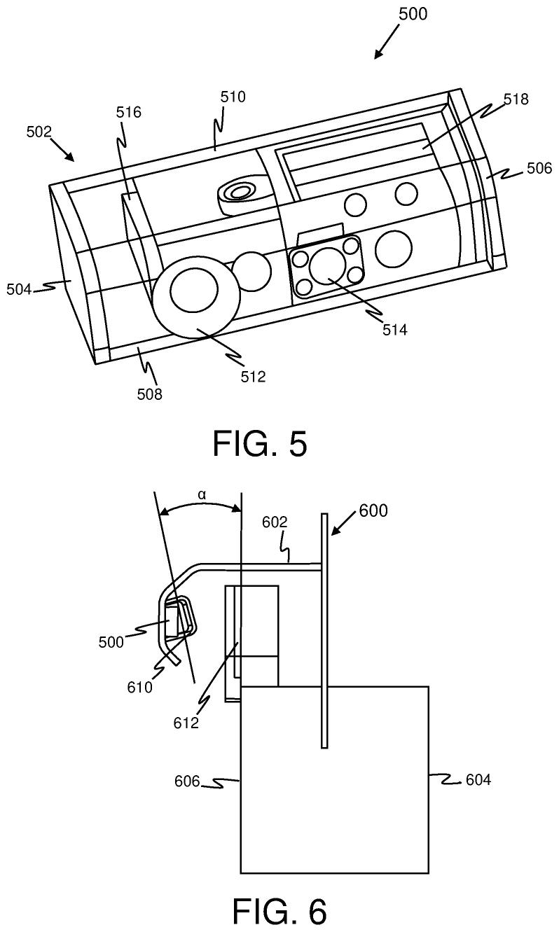

Referring to FIG. 5, there is shown a perspective view of an imaging device 500 (such as the at least one imaging device 202A-C of FIG. 2) for capturing image, in accordance with an embodiment of the present disclosure. As shown, the imaging device 500, includes a first housing structure 502 having the end walls 504 and 506 that forms the left-hand and right-hand side of the first housing structure 502 respectively. Furthermore, first housing structure 502 includes side walls 508 and 510 forming the front and the rear sides of the first housing structure 502 respectively. Additionally, the side wall 508 includes at least one opening 512 for movement of the lens assembly of the imaging device 500 for capturing the at least one image. Furthermore, the first housing structure 502 include additional opening 514 for enabling immersion of light from a light source (such as, a flash light). Moreover, the imaging device 500 is arranged within the second holding structure 516. Furthermore, imaging device 500 includes a first controlling unit 518 that is attached to the first housing structure 502 and operatively coupled to the second holding structure 516. Furthermore, the imaging device 500 shows a position (the second position) of the second holding structure 516, wherein the imaging device 500 is arranged in a position that the imaging device 500 is capable of capturing the at least one image.

Optionally, the imaging device 500 may include miniature camera having a manual focusing lenses use M12X 0.5 mm or with S lens. Moreover, the difference between two equivalent lenses of plurality of lens included in the imaging device 500 may have a diagonal angle 78°. Furthermore, the manually focusing the lens in the plurality of lens may have an aperture of about 12 mm. Additionally, the imaging device 500 with manual focus may have an opening of 12 mm, wide angle 78° and plate thickness 3 mm. Furthermore, the imaging device 500 may include autofocusing lens having an opening of about 3.4 mm. Optionally the imaging device 500 autofocusing lens may have a lens diameter of 2 mm requires only an opening in the camera house of to 3.4 mm inside and 8.26 mm outside when the wall thickness of the camera body may be 3 mm. Optionally, the imaging device 500 includes first damping component arranged between the second holding structure 516 and the imaging device 500, and a dampening structure on the at least one opening 512 of the first housing structure 502.

Referring to FIG. 6, there is shown a perspective view of the position of the imaging device 500 of FIG. 5 on a head 600 of the forest harvester for capturing image of a planner portion 606 of a log 604, in accordance with an embodiment of the present disclosure. As shown, the head 600 of the forest harvester includes an arm 602 that holds the log 604 for cutting/chopping. Additionally, a protective component 610 is arranged on the head 600 of the forest harvester. Furthermore, the protective component 610 holds the imaging device 500 with the head 600 of the forest harvester in a manner that the imaging device 500 is substantially perpendicular to the planner portion 606 of the log 604. Furthermore, shown is a side view of the imaging device 500 in a position that is relative a sword 612 of the head 600 of the forest harvester. Optionally a may be an angle between a longitudinal axis of the imaging device 500, and the planner portion 606 of the log 604. In such instance, the angle (value of a) may be approximately 15°.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1-31. (canceled)

32. A method of identifying an object using at least one imaging device, wherein the method comprises:
acquiring calibration information for each of the at least one imaging device arranged substantially perpendicular to a planar surface of the object;
capturing an image of the planar surface of the object using each of the at least one imaging device;
generating a transformed image corresponding to each image of the planar surface of the object, using the calibration information of the at least one imaging device used for capturing each image;
generating a security map for each transformed image, wherein the security map comprises a weightage factor for each pixel of the transformed image, and wherein the weightage factor is based on image resolution of the transformed image; and
constructing a resultant image of the planar surface of the object using each transformed image and the security map for the transformed image, to identify the object.

33. A method of claim 32, wherein the calibration information for each of the at least one imaging device comprises at least one of: position of the at least one imaging device with respect to the object, functional parameters of the at least one imaging device.

34. A method of claim 32, further comprising generating the calibration information for each of the at least one imaging device.

35. A method of claim 34, further comprising generating a warp map using the calibration information for each of the at least one imaging device, wherein the warp map is associated with a transformation matrix.

36. A method of claim 32, wherein the weightage factor is calculated as an inverse of a distance of the pixel, from at least one pixel positioned near the pixel in the transformed image.

37. A method of claim 32, further comprising normalizing the at least one transformed image using a local mean intensity technique.

38. A method of any one of the claims 33 to 37, further comprising determining an error associated with change in position of the at least one imaging device with respect to the object, wherein the error is determined based on a difference in relative location of at least one of: a key-point, and/or a reference item in the transformed images.

39. A method of claim 38, further comprising modifying the transformed image to compensate for the determined error.

40. A method of claim 38, further comprising adjusting the position of the at least one imaging device based on the determined error.

41. A method of claim 32, wherein the planar surface is a side of a log.

42. A method of claim 41, wherein the at least one imaging device is operatively coupled to a head of a forest harvester.

43. An arrangement for identifying an object, wherein the arrangement comprises:
at least one imaging device arranged substantially perpendicular to a planar surface of the object; and
a data processing apparatus operatively coupled to the at least one imaging device, wherein the data processing apparatus is operable to:
acquire calibration information for each of the at least one imaging device arranged substantially perpendicular to the planar surface of the object;
capture an image of the planar surface of the object using each of the at least one imaging device;
generate a transformed image corresponding to each image of the planar surface of the object, using the calibration information of the at least one imaging device used for capturing each image;
generate a security map for each transformed image, wherein the security map comprises a weightage factor for each pixel of the transformed image, and wherein the weightage factor is based on image resolution of the transformed image;
construct a resultant image of the planar surface of the object using each transformed image and the security map for the transformed image; and
identify the object using the resultant image of the planar surface of the object.

44. An arrangement of claim 43, wherein the at least one imaging device is a high-resolution digital camera.

45. An arrangement of any one of the claim 43 or 44, wherein the planar surface is a side of a log.

46. A system for identifying a log, wherein the system comprises:
a forest harvester;
at least one imaging device coupled to the forest harvester, wherein the at least one imaging device is mounted on a head of the forest harvester; and
a data processing apparatus operatively coupled to the at least one imaging device, wherein the data processing apparatus is operable to:
acquire calibration information for each of at least one imaging device arranged substantially perpendicular to a side of the log;
capture an image of the side of the log using each of the at least one imaging device;
generate a transformed image corresponding to each image of the side of the log, using the calibration information of the at least one imaging device used for capturing each image;
generate a security map for each transformed image, wherein the security map comprises a weightage factor for each pixel of the transformed image, and wherein the weightage factor is based on image resolution of the transformed image;
construct a resultant image of the side of the log using each transformed image and the security map for the transformed image; and
identify the log using the resultant image of the side of the log.

47. A system of claim 46, further comprising at least one hinge assembly, wherein each of the at least one imaging device is mounted on the head of the forest harvester using the at least one hinge assembly.

48. A system of claim 47, further comprising at least one actuator assembly operatively coupled to the at least one least one imaging device, wherein the at least one actuator assembly is operable to modify a position of the at least one imaging device.

49. A system of claim 48, wherein the data processing apparatus is further operable to transmit a signal to the at least one actuator assembly to modify the position of the at least one imaging device.

50. A system of claim 46, further comprising at least one vibration damping assembly operatively coupled to the at least one imaging device.

51. A system of claim 46, further comprising a server arrangement communicatively coupled to the data processing apparatus, wherein the data processing apparatus is operable to transmit the resultant image of the side of the log to the server arrangement.
